(19) United States
(12) Patent Application Publication
(10) Pub. No.: US 2001/0027424 A1
(43) Pub. Date: Oct. 4, 2001

(54) Transaction support system

(76) Inventor: Shin Torigoe, Osaka (JP)

Correspondence Address: VENABLE, Post Office Box 34385, Washington, DC, 20043-9998, US

(21) Appl. No.: 09/810,211

(22) Filed: Mar. 19, 2001

(30) Foreign Application Priority Data
Mar. 31, 2000 (JP) JP2000-101240

(51) Int. Cl. G06F 17/60

(52) U.S. Cl. 705/26

(57) ABSTRACT

A transaction support system that achieves a reduction in the transaction fees is provided.

The transaction support system comprises a remittance job detection unit 1 that receives a deposit paid by a buyer 20 for the purchase of a product and accepts a request for remitting the payment to a vendor 30 of the product, a personal information database 2 at which personal information with regard to the buyer 20 and the vendor 30 is accumulated, a deposit notification unit 3 that notifies the vendor 30 of the receipt of the deposit from the buyer 20, a receipt confirmation unit 4 at which receipt of the product is confirmed with a product receipt confirmation, a transaction history database 5 at which transaction history data are accumulated, a payment remittance unit 6 that remits the payment for the product to the vendor 30, a transaction information notification unit 7 that provides a carrier 40 of the product with transaction information based upon the data at the transaction history database, a credit/debit unit 8 that credits/debits an account of the carrier 40 and a management fund control unit 9 that controls a management fund. The transaction information notification unit collectively provides a plurality of sets of transaction information to the carrier and the carrier deposits a specific fee in response to the transaction information notification it has received at the credit/debit unit.

### BACKGROUND OF THE INVENTION

The present invention relates to a transaction support system, and more specifically, it relates to a transaction support system in electronic commerce that utilizes network technology.

The rapid progress in recent network technology has boosted the number of transactions through electronic commerce such as the ones made between buyers and virtual stores through on-line shopping, and the ones made among non-merchants through auctions and flea markets.

### PRIOR ART

In the electronic commerce in the prior art, the vendor of a product ships the product after the buyer of the product makes the payment or the buyer remits or makes the payment after he receiving the product shipped by the vendor. However, since one party has to ship the product or the other party has to remit the payment in good faith in this transaction style, numerous cases of abuse have been reported and it has proved difficult to carry out a transaction that is reliable for both the buyer and the vendor.

As a solution to the problem discussed above, transaction support systems that temporarily hold payments have come into existence. In such a transaction support system, a transaction is carried out through the following procedure. First, the buyer remits the payment to an agent, who offers the service of temporary payment holding. Next, the agent notifies the vendor of the fact that the remittance has been made by the buyer. After confirming the fact that the buyer has remitted the payment, the vendor ships the product. When the buyer notifies the agent that the product has been accepted, the agent forwards the payment to the vendor.

In the transaction support system described above, the fee for temporary payment holding charged by the agent is several percent of the payment, or a fixed fee is applied. Thus, there is a problem in that the system is not suitable to be utilized in small-scale transactions. Moreover, even if the fee for temporary payment holding is set low, two remittances must be made for the payment from the buyer to reach the vendor via the agent. Therefore, there is a problem in that two bank transaction fees must be incurred for a single payment.

### SUMMARY OF THE INVENTION

The present invention has been made to respond to the problems of the transaction support systems in the prior art discussed above. The object of the present invention is to provide a new and improved transaction support system that makes it possible to reduce the transaction fee.

In order to achieve the object described above, the transaction support system introduced by the present invention comprises a remittance job detection unit that receives a deposit paid by a buyer of a product and accepts a request to remit the payment to the vendor of the product, a personal information database at which personal information with regard to the buyer and the vendor is accumulated, a deposit notification unit that notifies the vendor that the buyer has deposited the payment, a receipt confirmation unit at which the buyer inputs a product receipt confirmation, a transaction history database at which transaction history data are accumulated, a payment remittance unit that remits the payment for the product to the vendor, a transaction information notification unit that notifies the carrier of the product of transaction information based upon the data in the transaction history database, a credit/debit unit that credits/debits the account of the carrier and a management fund control unit that controls a management fund. The transaction information notification unit notifies the carrier by sending a plurality of sets of the transaction information all together and a specific fee is paid into the credit/debit unit by the carrier based upon the contents of the transaction information that the carrier receives.

It is to be noted that in this specification, the term “remittance” is used to generically refer to a transfer of money from one party (e.g., a buyer) to another party (e.g., a vendor) in any form, including a remittance by mail or the like, a remittance made through a bank deposit, a payment made on a credit card and a direct transfer of cash.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments. In the drawings:

FIG. 1 illustrates the transaction support system in a first embodiment;

FIG. 2 illustrates the flow of the processing implemented in the first embodiment;

FIG. 3 illustrates the transaction support system in a second embodiment;

FIG. 4 illustrates the flow of the processing implemented in the second embodiment;

FIG. 5 illustrates the transaction support system in a third embodiment; and

FIG. 6 illustrates the flow of the processing implemented in the third embodiment.

### DETAILED DESCRIPTION OF THE PREFERRED EMBODIMENTS

The following is a detailed explanation of the preferred embodiments of the transaction support system according to the present invention, given in reference to the attached drawings. It is to be noted that in the specification and the drawings, the same reference numbers are assigned to components having substantially identical functions and structural features, in order to preclude repeated explanations.

### First Embodiment

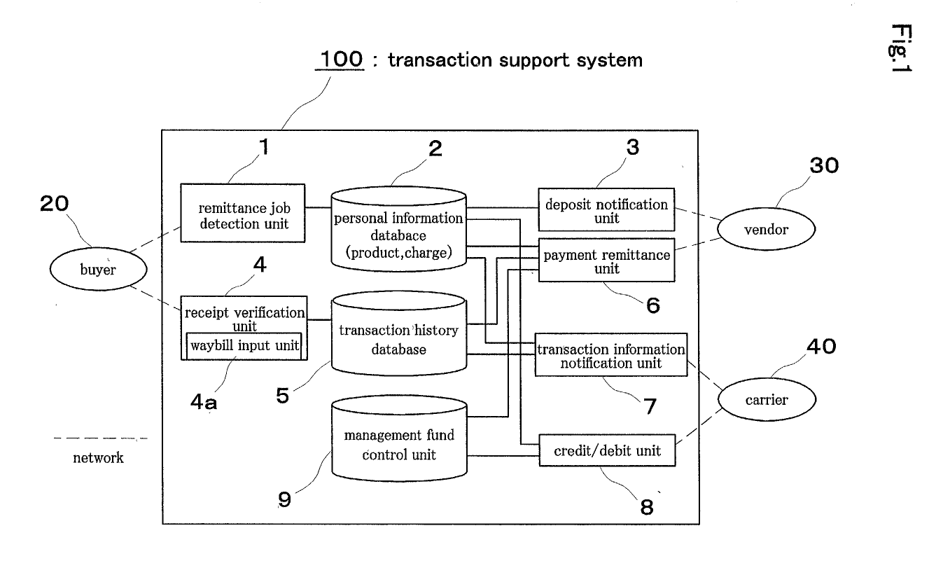

The transaction support system in the first embodiment is explained in reference to FIG. 1.

As shown in FIG. 1, a transaction support system 100 comprises a remittance job detection unit 1 that receives a deposit paid by a buyer 20 of a product and accepts a request for remitting the payment to a vendor 30 of the product, a personal information database 2 at which personal information with regard to the buyer 20 and the vendor 30 is accumulated, a deposit notification unit 3 that notifies the vendor 30 of the receipt of the deposit from the buyer 20, a receipt confirmation unit 4 at which the buyer 20 confirms receipt of the product, a transaction history database 5 at which transaction history data are accumulated, a payment remittance unit 6 that remits the payment for the product to the vendor 30, a transaction information notification unit 7 that provides a carrier 40 of the product with transaction information (the history, the tabulation, etc.) based upon the data at the transaction history database, a credit/debit unit 8 that credits/debits the account of the carrier 40 and a management fund control unit 9 that controls a management fund utilized in the system 100.

At the remittance job detection unit 1, the buyer 20 may pay the deposit by providing his bank account number or a credit card number. At the personal information database 2, personal information with regard to a user of the system (may be either the buyer 20 or the vendor 30), such as the user's e-mail address, postal address, ordered item, bank balance is accumulated. The receipt confirmation unit 4 may include a waybill input unit 4a that allows an input of the waybill used in the transportation of the product.

While only one for each of the buyer 20, the vendor 30 and the carrier 40 is shown in FIG. 1, to simplify the illustration, a plurality of buyers, a plurality of vendors and a plurality of carriers can be connected with this transaction support system 100. It can be understood easily by a person skilled in the art that great numbers of buyers and vendors may be connected with the transaction support system 100 under normal circumstances. When the system handles personal transactions among non-merchants, such as auctions and flea markets, either user of the system can be both the buyer 20 and the vendor 30 depending upon the situation.

The various components constituting the transaction support system 100 may be provided on a single server which is separated from that of the buyer 20, the vendor 30 and the carrier 40, or they may be divided over the individual servers of the buyer 20, the vendor 30 and the carrier 40, which are connected in a network to enable coordinated operation.

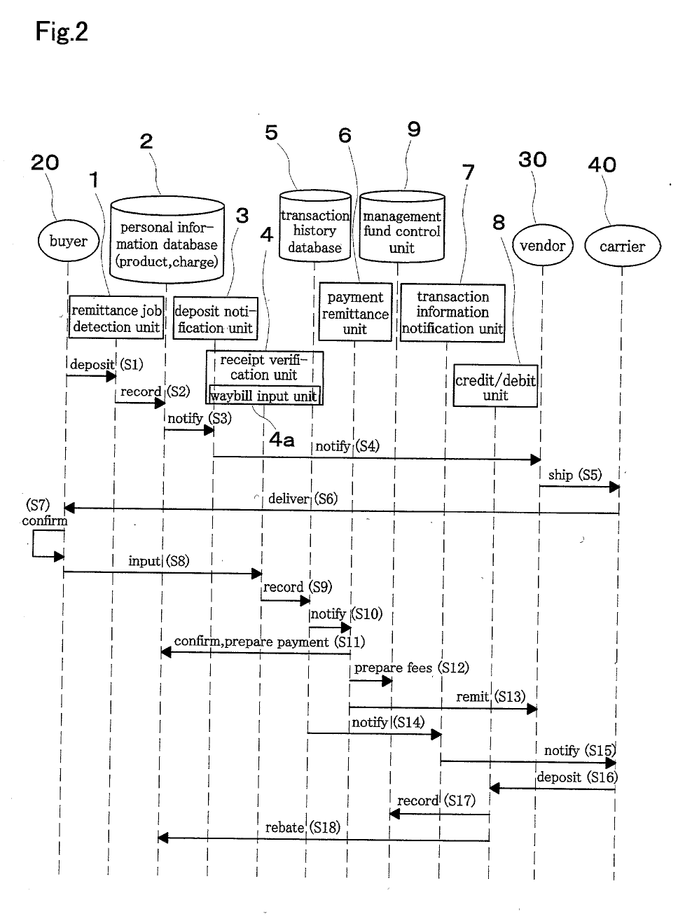

Next, the flow of a transaction carried out in the transaction support system 100 is explained in detail in reference to FIG. 2.

After a transaction agreement is reached with the vendor 30, the buyer 20 deposits the payment for the product and the necessary fees and issues a remittance request to the remittance job detection unit 1 (step S1). The required fees deposited in this step include fees required for the shipment of the product and the remittance, and fees required for the fund transfer/debit. While the system according to the present invention is similar to the systems in the prior art in that the buyer 20 deposits the fees required in the transaction, the first embodiment is characterized in that part of or all of the fees may be refunded to the buyer.

The fees deposited by the buyer 20 are controlled by the management fund control unit 9 as the management fund for the system. The fees may be deposited each time the buyer 20 purchases a product, or a membership system, whereby the system serves regular users and a specific membership fee is collected to be utilized as the management fund, may be adopted. When such a membership system is adopted, too, the fees are returned, as explained later, and a reduction in the fees compared to those applied in the systems in the prior art can be achieved.

The information with regard to the deposit paid by the buyer 20 in step S1 is recorded in the personal information database 2, (step S2) and also is sent to the deposit notification unit 3 (step S3). The deposit notification unit 3 notifies the vendor 30 of the deposit paid by the buyer 20 (step S4).

Upon confirming that the deposit has been made by receiving the deposit notification in step S4, the vendor 30 ships the product to the buyer 20. The transportation of the product is handled by the carrier 40 designated in the system via, for instance, a convenience store, an agency or the like. Namely, the vendor 30 first ships the product to the carrier 40 (step S5), and the carrier 40 delivers the product to the buyer 20 (step S6).

The buyer 20 checks the received product (step S7) and enters a receipt confirmation at the receipt confirmation unit 4. Since the receipt confirmation unit 4 includes the waybill input unit 4a in the transaction support system 100 in the embodiment, the receipt can be confirmed by inputting the waybill (step S8). The receipt confirmation thus entered is recorded in the transaction history database 5 as transaction history data (step S9).

Next, based upon the data recorded in the transaction history database 5, a payment remittance procedure is executed (step S10). First, preparation for debiting the payment is performed at the personal information database 2 (step S 11) and, in response, the remittance fee or the withdrawal fee incurred by the vendor 30 is made available to be paid out of the management fund control unit 9 (step S12). The total sum of money, which is calculated by adding the payment for the purchased product and, if necessary, the withdrawal fee incurred by the vendor 30 is remitted to the vendor 30 (step S13).

The transaction information based upon the data in the transaction history database 5 is sent to the transaction information notification unit 7 (step S14), and a plurality of sets of such transaction information are collectively transmitted by the transaction information notification unit 7 to the carrier 40 (step S15). The carrier 40 thus receives the results of the product deliveries from the system on a regular basis, and deposits a specific fee at an amount corresponding to the contents of the transaction information notification that has been received, e.g., a fee at a sum equivalent to a discount on the delivery fees or a brokerage fee, through the credit/debit unit 8 (step S16).

The deposit paid in step S16 is recorded in the management fund control unit 9 (step S17) and accordingly, a rebate is awarded to the buyer 20 (step S18). The amount of the rebate is recorded in the personal information database 2 and is applied to a subsequent transaction. When the buyer 20 wishes to use the rebate in a subsequent transaction, the buyer 20 requests the remittance job detection unit 1 for a transfer instead of making a deposit in step S1. In addition, if the payment to the vendor 30 is to be made in cash on delivery, the payment details are recorded as personal information of the vendor 30 in the personal information database after steps S16 and S18.

As explained above, the first embodiment makes it possible for an agent to receive a discount equivalent to that on a large contract between the buyer 20 and vendor 30 by collectively providing the carrier 40 with a plurality of sets of transaction information. By allocating the gain made through this discount service to supplement the expenses of the vendor 30 or to award the buyer 20 with a rebate, a reduction in the transaction fees can be achieved. In addition, savings obtained through the discounts may be accumulated to be offered as a discount when the buyer 20 makes a payment or to be allocated to cover the transfer fees that should be incurred in individual transactions.

Furthermore, when a user is both a vendor and a buyer, the payments for the products he has purchased may be made out of a fund pool in which payments he has collected are accumulated or he may arrange to have the payments to be debited from a registered account on a fixed date of settlement, to minimize the amount of money he pays as transaction fees. By settling a plurality of payments all at once and clearing only the difference between the balances of payments among a plurality of buyers and a plurality of vendors, various fees applied in individual transactions can be minimized.

Since the receipt confirmation unit 4 includes the waybill input unit 4a at which the waybill used for the transportation of the product is input, and only a notification to carrier personnel is required without necessitating any changes in the terminal operation, the system can be configured smoothly.

Even when the buyer 20 makes a payment by using a bank account number or with a credit card at the remittance job detection unit 1, the vendor is not notified of the bank account number or the card ID to protect the buyer 20.

Moreover, since the system is configured on a computer connected in a network, actions (deposit, shipment) by the parties to the transaction at remote locations, the balance of payments and the like can be confirmed in real time.

### Second Embodiment

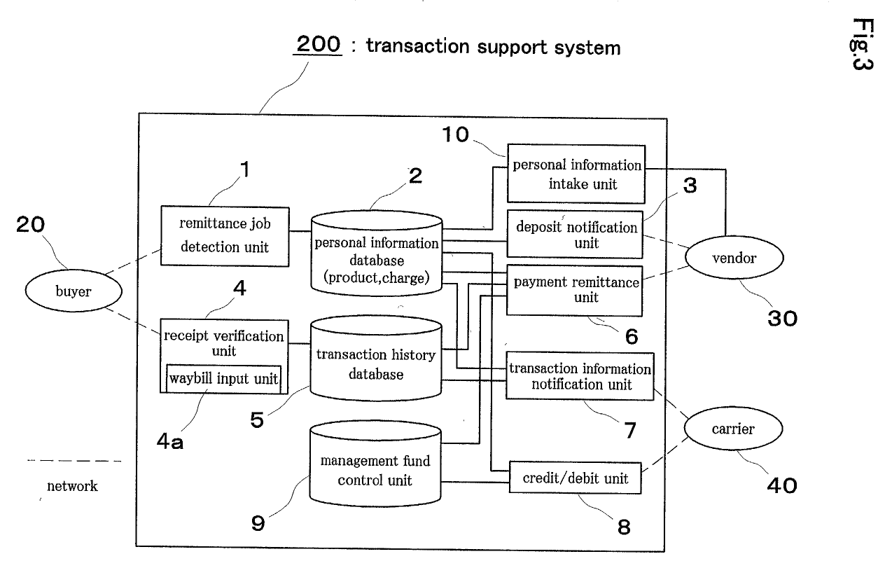

The transaction support system in the second embodiment is now explained in reference to FIG. 3.

A transaction support system 200 in this embodiment is an application of the first embodiment explained above, and as illustrated in FIG. 3, it is characterized in that it further comprises a personal information intake unit 10 that enables the buyer 20 and the vendor 30 to access the personal information database 2. It is to be noted that since other structural features are essentially identical to the various components in the first embodiment, their explanation is omitted.

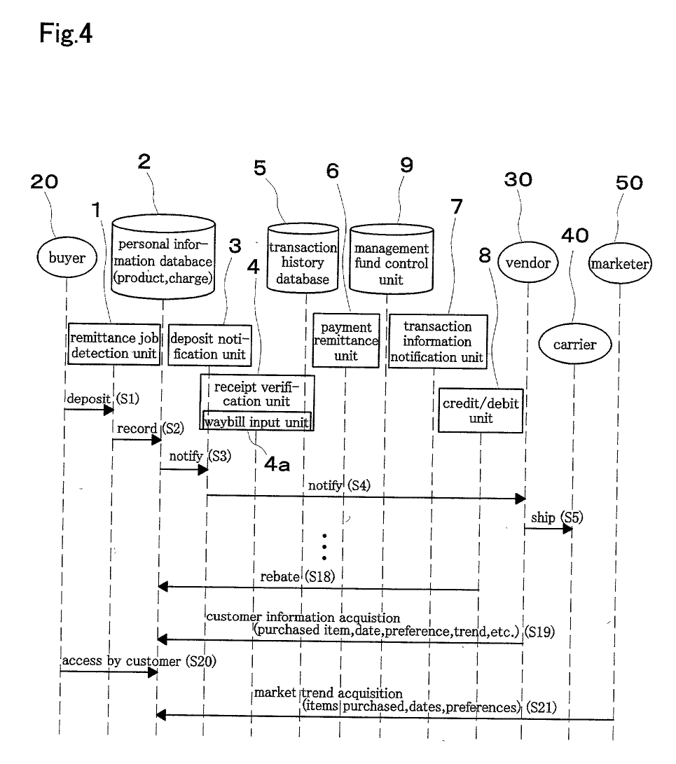

Next, the flow of the transaction carried out in the transaction support system 200 is explained in detail in reference to FIG. 4. The steps implemented during a transaction (steps S1˜S18) are identical to those in the first embodiment.

When the transaction is completed, the vendor 30 accesses the personal information database 2 through the personal information intake unit 10 to obtain personal information regarding the buyer 20 (step S19). This personal information may be utilized as customer information to enable the vendor 30 to offer product support or to collect the response to a questionnaire.

While the buyer 20 is able to refer the updated information such as the current contact address of the vendor 30 through the personal information intake unit 10 when inquiring to the vendor 30 about a product purchased from the vendor 30 (step S20).

In addition, to a new participant (marketer) 50 conducting marketing operations, personal information can be disclosed via the personal information intake unit 10 (step S2 1) while ensuring that the privacy of the users is protected.

As explained above, by providing a means for access that enables the vendor 30 to access the personal information database 2, easy and inexpensive customer management is enabled in the second embodiment. Thus, the transaction support system 200 can be utilized by small retailers and large corporations as well as for transactions between individuals, and when used by businesses, the cost of customer base control can be substantially reduced. In addition, since the buyer 20 and the vendor 30 can obtain the updated information about each other, it is not necessary to send special notices of changes in the personal information such as a change of address. It allows to reduce the risk of forgetting to report a change and the trouble of having to report a change.

### Third Embodiment

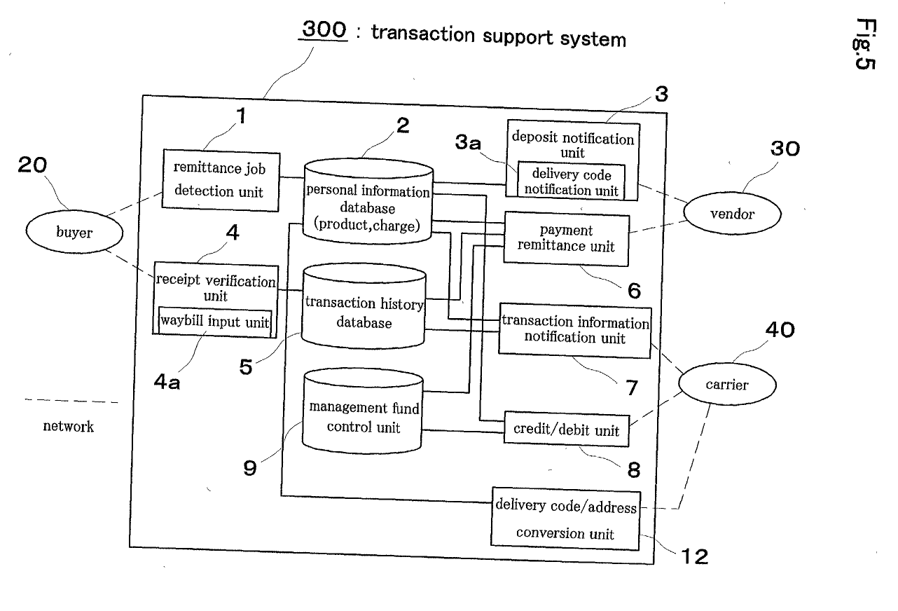

The transaction support system in the third embodiment is now explained in reference to FIG. 5.

A transaction support system 300 in this embodiment, which is an application of the first embodiment explained earlier. As shown in FIG. 5, the deposit notification unit 3 includes a delivery code notification unit 3a that notifies the vendor of a product destination as a delivery code, and a delivery code/address conversion unit 12 that enables the carrier 40 to obtain the address of the recipient in correspondence to the delivery code. The delivery code/address conversion unit 12 is connected allowing to be accessed from a collection/delivery station at the carrier 40. It is to be noted that since other components are essentially identical to the various components in the first embodiment, their explanation is omitted.

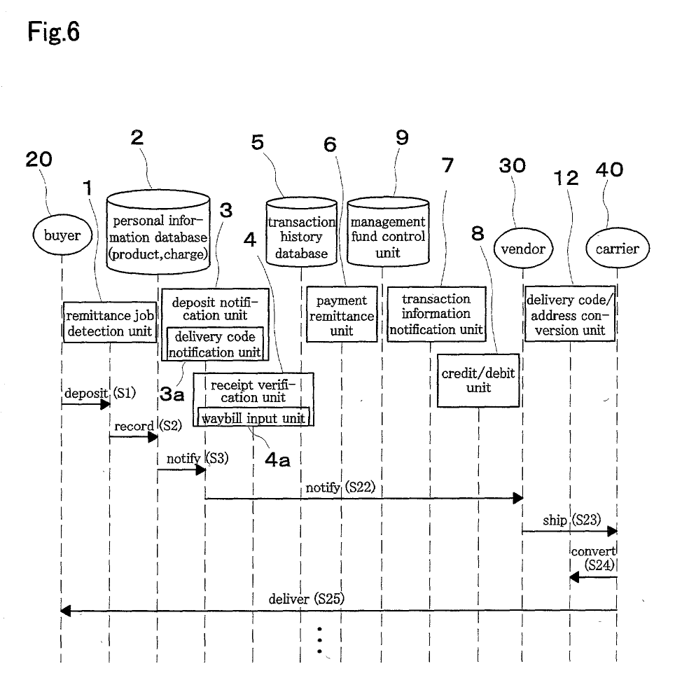

Next, the flow of a transaction carried out in the transaction support system 300 is explained in reference to FIG. 6. It is to be noted that a step in which the buyer 20 deposits the payment (step S1), a step in which data are recorded in the personal information database 2 (step S2) and a step in which a notification of the deposit is sent to the deposit notification unit 3 (step S3) are identical to those implemented in the first embodiment.

Next, the vendor 30 receives the recipient code together with the deposit notification from the deposit notification unit 3 (step S22). The notification of the delivery code is transmitted by the delivery code notification unit 3a included in the deposit notification unit 3. Upon confirming that the deposit has been completed, the vendor 30 ships the product after entering the delivery code in the address section of the waybill (step S23). During the process, the vendor 30 is notified only of the delivery code, and does not receive any other information about the buyer 20.

Through delivery code/address conversion, the carrier 40 obtains the correct address for delivery and enters the address in the waybill (step S24). The carrier 40 then makes a delivery to the correct address (step S25).

It is to be noted that the transaction support system 300 in the embodiment may further comprise the personal information intake unit 10 provided in the second embodiment.

As explained above, by adding a processing block that engages in delivery code/address conversion to the structure adopted in the first embodiment, an advantage is achieved in that it is not necessary for the buyer 20 to divulge personal information such as the address and telephone number to the vendor 30. In addition, by encoding the delivery code together with the registration code of the vendor 30, it is possible to block unwanted direct mail from unregistered parties.

While the preferred embodiment of the transaaction support system of the present invention has been particularly described by referring to the attached drawings, the present invention is not limited to these examples. It will be understood by those skilled in the art that the various changes and amendments may be made therein to the extent that the technical principles of the patent application refers.

Described above is an example of the embodiment, in which fees required for the shipment of a product and remittance and fees required for fund transfer/debit are deposited by the buyer 20, and part of or all of such fees is returned to the buyer. The present invention is not limited to the extent. The fees required for the shipment of a product and the remittance and the fees required for the fund transfer/debit may be borne by the vendor 30 and the profits gained from the carrier 40 may be rebated to the vendor 30.

In addition, the transaction support system may bear the fees required for the fund transfer/debit, while the buyer or the vendor bears the fees required for product shipment and remittance. In such a case, the fees borne by the transaction support system should be paid with the profits gained from the carrier 40. In addition, the profit gained from the carrier 40 is rebated to the buyer or the vendor, who has borne the fees required for product shipment and remittance.

While an explanation has been given on an example in which the waybill input unit 4a is included in the receipt confirmation unit 4, the waybill input unit 4a is not necessarily an essential component. The receipt of a product can be confirmed in any method. For instance, the receipt of a product may be confirmed by telephone, fax or online.

If this system is directly run by an auction site vendor, a carrier service operator, or a business or an institution equipped with a means for payment settlement, a further reduction in the fees can be achieved.

The accumulated data compiled by using the personal information other than private data can be utilized in marketing activities for developing new products and cultivate a new customer entering new marketers. Also by making such information available, more management funds can be collected from those businesses.

As explained above, by using this invention, handling a plurality of sets of transaction information all at once, a discount service equivalent to that on a large contract can be applied by the carrier operator. By allocating the profit obtained in the discount service to cover the expenses incurred by the vendor or to rebate to the buyer, a reduction in the actual transaction fees can be achieved. In addition, such profits obtained by discount service from the carrier may be accumulated to be used for a discount applied at the time of fee payment or to be allocated to supplement the transfer fees which must be paid when handling individual transactions.

Furthermore, while a user is both a vendor and a buyer, the payments for the products he has purchased may be made out of a fund pool in which payments he has collected are accumulated or he may arrange to have the payments to be debited from a registered account on a fixed date of settlement, to minimize the amount of money he pays as transaction fees. By settling a plurality of payments all at once and clearing only the difference between the balances of payments among a plurality of buyers and a plurality of vendors, various fees applied in individual transactions can be minimized.

Moreover, even when a buyer settles the payment through a bank account or a credit card, the vendor is not notified of the bank account number or the card ID to ensure the safety of the transaction.

Since the system is configured on a computer connected to a network, actions (deposit, shipment) by a party at a remote location, and the balance of payments and the like can be confirmed in real time.

In addition, since only a notification to carrier personnel is required without necessitating any changes in the terminal operation, the system can be configured smoothly.

By providing a means that enables the vendor to access to the personal information database, easy and inexpensive customer management is enabled. Thus, the transaction support system can be utilized by small retailers and large corporations as well as for transactions between individuals. When used by businesses, the cost of customer base control can be substantially reduced. In addition, since the buyer and the vendor can obtain the updated information with regard to each other, it is not necessary to send special notices of changes in the personal information such as a change of address. It allows to reduce the risk of forgetting to report a change and the trouble of having to report a change.

A further advantage is achieved in that it is not necessary for the buyer 20 to divulge personal information such as his address and telephone number to the vendor. In addition, by encoding the delivery code together with the registration code of the vendor, it is possible to block unwanted direct mail from unregistered parties.

What is claimed is;

1. A transaction support system comprising:
a remittance job detection unit that receives a deposit paid by a buyer of a product and accepts a request to remit a payment to a vendor of said product;
a personal information database at which personal information with regard to said buyer and said vendor is accumulated;
a deposit notification unit that notifies said vendor that said buyer has deposited said payment;
a receipt confirmation unit at which said buyer enters a product receipt confirmation;
a transaction history database at which transaction history data are accumulated;
a payment remittance unit that remits said payment for said product to said vendor;
a transaction information notification unit that provides a carrier of said product with transaction information based upon the data at said transaction history database;
a credit/debit unit that credits/debits an account of said carrier and;
a management fund control unit that controls a management fund, wherein;
said transaction information notification unit collectively provides said carrier with a plurality of sets of transaction information; and
a specific sum of fees corresponding to the contents of said transaction information provided to said carrier is deposited into said credit/debit unit by said carrier.

2. A system according to claim 1, wherein;
said receipt confirmation unit includes a waybill input unit at which a waybill used for the transportation of said product is input.

3. A system according to claim 1, further comprising a personal information intake unit that enables said buyer and said vendor to access said personal information database.

4. A system according to claim 1, having a delivery code notification unit that notifies said vendor of the delivery destination of said product as a delivery code provided in said deposit notification unit, further comprising;
a delivery code/address conversion unit through which said carrier obtains the address of the recipient in correspondence to said delivery code.

5. A system according to claim 1, wherein;
said buyer makes a deposit through a credit card at said remittance job detection unit.

6. A system according to claim 1, wherein;
a fee is deposited into said management fund control unit each time said buyer purchases a product.

7. A system according to claim 1 adopting a membership system to serve buyers who use said system on a regular basis as members, wherein;
membership fees are regularly deposited by said members into said management fund control unit.

8. A system according to claim 1, wherein;
fees required for product shipment and remittance and fees required for fund transfer/debit are incurred by said buyer and a specific fee deposited by said carrier is rebated to said buyer.

9. A system according to claim 1, wherein;
fees required for product shipment and remittance and fees required for fund transfer/debit are incurred by said vendor of said product and a specific fee deposited by said carrier is rebated to said vendor of said product.

10. A system according to claim 1, wherein;
fees required for product shipment and remittance are incurred by said buyer, fees required for fund transfer/debit are incurred by said system and the specific fee deposited by said carrier is rebated to said buyer and said system.

11. A system according to claim 1, wherein;
fees required for product shipment and remittance are incurred by said vendor of said product, fees required for fund transfer/debit are incurred by said system and the specific fee deposited by said carrier is rebated to said vendor of said product and said system.

12. A system according to claim 1, wherein;
said buyer confirms the receipt of said product by telephone, facsimile or online.
